(19) United States
(12) Patent Application Publication
(10) Pub. No.: US 2008/0082549 A1
(43) Pub. Date: Apr. 3, 2008

(54) Multi-Dimensional Web-Enabled Data Viewer

(76) Inventors: Vic Baker, Morgantown, WV (US); Doru Pacurari, Morgantown, WV (US); Takamitsu Kawai, Morgantown, WV (US); Trevor Harris, Morgantown, WV (US)

Correspondence Address: Dennis M. Carleton, Esquire;Fox Rothschild LLP, 29th Floor, 625 Liberty Avenue, Pittsburgh, PA, 15212, US

(21) Appl. No.: 11/866,379

(22) Filed: Oct. 2, 2007

Related U.S. Application Data
(60) Provisional application No. 60/848,734, filed on Oct. 2, 2006.

(51) Int. Cl. G06F 17/30

(52) U.S. Cl. 707/10; 707/E17.001

(57) ABSTRACT

A system and method for the rendering and display of multi-dimensional data on a thin client. The system allows for the collection of multi-dimensional data layers from internet servers, the compositing of the layers and the rendering of the layers as rasterized images to be sent to a client or in a scene descriptor language for interpretation by a client. The system also allows for the creation and display of multi-media objects overlaid onto the images.

### RELATED APPLICATIONS

This application claims the benefit of U.S. provisional patent application, Ser. No. 60/848,734, filed Oct. 2, 2006, entitled “Multi-Dimensional Web-Enabled Data Viewer”

### BACKGROUND OF THE INVENTION

Current methods for interacting with multi-dimensional (2.5D or greater) environments typically require a dedicated software installation with a powerful client-side computer. Known instances of such methods require the installation on the client side of dedicated desktop applications to allow the viewing and navigation of such environments. Current examples of these types of applications include Microsoft Virtual Earth and Google Earth.

It would therefore be desirable to provide the user the ability to view and navigate multi-dimensional views with existing desktop programs, such as a typical web browser, without the necessity of installing compute-intensive desktop applications (i.e., a “thin client” approach). This approach allows mobile platform as well as desktop platforms to be used.

### SUMMARY OF THE INVENTION

The thin-client approach of this invention is achieved by utilizing server-side compute power to perform computationally intensive operations such as vector data manipulation and rendering of multi-dimensional graphical data. Once the server side has created rasterized perspective snapshots representing relevant server-side data, the snapshots are available to a variety of client platforms, such as desktop or mobile systems. The rasterized images are then sent to the thin client to be displayed using a simple web browsing program with, in the preferred embodiment of the invention, no need for additional software or plug-ins.

The invention is able to provide intuitive user navigation (similar to flying a helicopter over a landscape), and also provides the ability to create and store multi-media, user-definable features, referred to herein as “geoFeatures,” embedded within the context of the environment, regardless of what the data represents. The geoFeatures may also be associated with artificial intelligence behaviors to allow agent-like capabilities. In addition, multiple data overlays and searching capabilities are provided.

GeoFeatures are multi-dimensional data, representing points, lines or polygons with a spatial or temporal relationship with the terrain or other data set on which they are overlaid, and integrated into the real-world environment. The user-definable geoFeatures may also hold ancillary information, such as location information, temporal information, images, video, sound or other associated media. The geoFeatures are overlaid by computing rasterized locations based on their multi-dimensional scene coordinates. The system describes a geoFeature rasterizer which is responsible for converting from the geoFeature coordinate system to the appropriate raster coordinate system based on the user's view parameters.

All embodiments provide the ability for a user to click on the graphical rendition (be it a rasterized image or a multi-dimensional client-side render). This click is converted to the appropriate geographic coordinate, and the user can create geoFeatures at the specified location. Data text entry menus and fields are provided by the accompanying web based tools common in all embodiments of the invention.

The invention can be used to view multi-dimensional data of any type and in any disciplines, for example, financial and medical sector data.

### DESCRIPTION OF THE FIGURES

FIG. 1 shows a model of a geoFeature, including various attributes associated therewith.

FIG. 2 is a conceptual overview of a first embodiment of the invention.

FIG. 3 is a system diagram of a first embodiment of the invention utilizing pre-rendered multi-dimensional images.

FIG. 4 is an conceptual overview of the retrieval of data from external sources with respect to various embodiments of the invention.

FIG. 5 is a system diagram of a second embodiment of the invention including an on-demand image renderer.

FIG. 6 is an overview of the rasterization process of a 3D scene.

FIG. 7 is a system diagram of a third embodiment of the invention which includes an embedded rendering application on the client side.

FIG. 8 is an conceptual overview of a fourth embodiment of the invention.

FIG. 9 shows a system diagram of a fourth embodiment of the invention which utilizes a thin client having a scene description language interpreter on the client side and which features a server which creates scene descriptions instead of rasterized images.

### DETAILED DESCRIPTION OF THE INVENTION

The invention is comprised of four embodiments, with the difference between the embodiments being the level of processing that takes place on the server side versus the client side. All of the embodiments represent an improvement over prior art desktop applications in which the majority of the rendering processing takes place client-side on the desktop, for example, as a separate executable file.

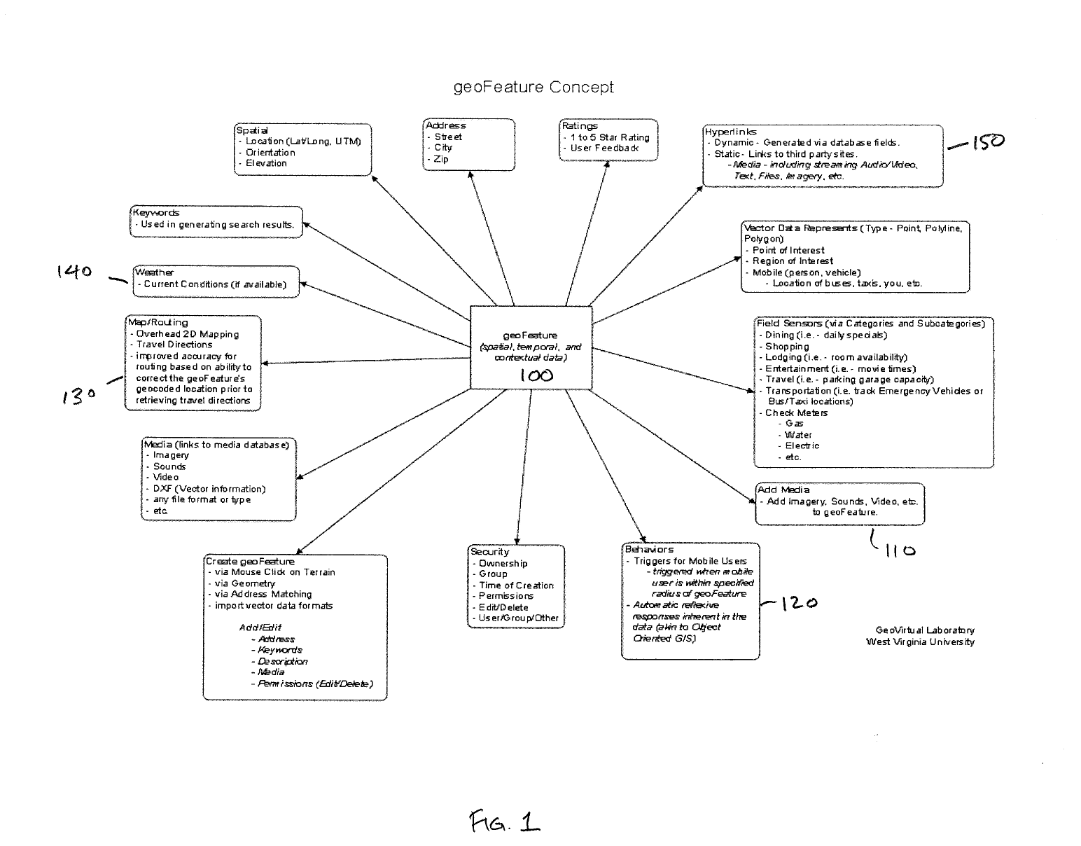

FIG. 1 shows a model of a geoFeature. A geoFeature 100 enables various types of user-defined features to be viewed as an overlay to the data, regardless of what the data represents. The model shown in FIG. 1 provides examples of information that can be associated with a geoFeature. GeoFeatures may be represented by points, multi-segmented lines or polygons on a rendering of the data set with which they are overlaid and are spatially, temporally or contextually associated in some manner with that data set.

A geoFeature may have different types of information associated with it, for example, media information, such as sounds, images or video 110, weather information 140 or real-world map routing information 130. This information may be stored on the server in a database or may be linked to via a hyperlink 150.

GeoFeatures may also have certain associated behaviors 120, such that the geoFeature may act as an intelligent agent to perform various functions. For example, a geoFeature representing a temperature sensor at a particular location may have the behavior of collecting a temperature reading at periodic intervals and reporting it.

Because geoFeatures may have a temporal relationship to the data on which they are overlaid, they may be mobile with respect to the data, or may represent changes to the data over time. For example, a geoFeature may represent a moving object on a terrain, such as an aircraft in an air traffic control system, or a clinical change over time of a broken bone in a human body.

As an example of some of the uses of geoFeatures, Geographic Information Systems (GIS) data may use the geoFeatures to store location information for point, line and polygon data defining points of interest, along with media that is associated with each location, for example, images of the location, information about the location, etc.

Medical image data could utilize geoFeatures to show the location of an inflammation on a human body. The image data could also utilize geoFeatures in a temporal manner, showing changes in the affected area over time. Each geoFeature could also have various multi-media objects associated therewith, such as MRI images, PET scans, voice recordings, billing info, etc.

In yet another example of the use of geoFeatures, financial sectors may be able to link temporal data such as stock prices with events or circumstances affecting that stock price, such as other stock performances, political events, terrorist attacks, etc. The resulting linkages enable a user to find correlations between outside events and the variations in stock prices. Any number of links, such as links to other stocks, media, etc. can be tied together via the temporal terrain feature node. This is analogous to a growing multi-dimensional web of relating information, i.e., a temporal/spatial/contextually driven scene graph or tree.

GeoFeatures may be present in all embodiments of the invention, described below.

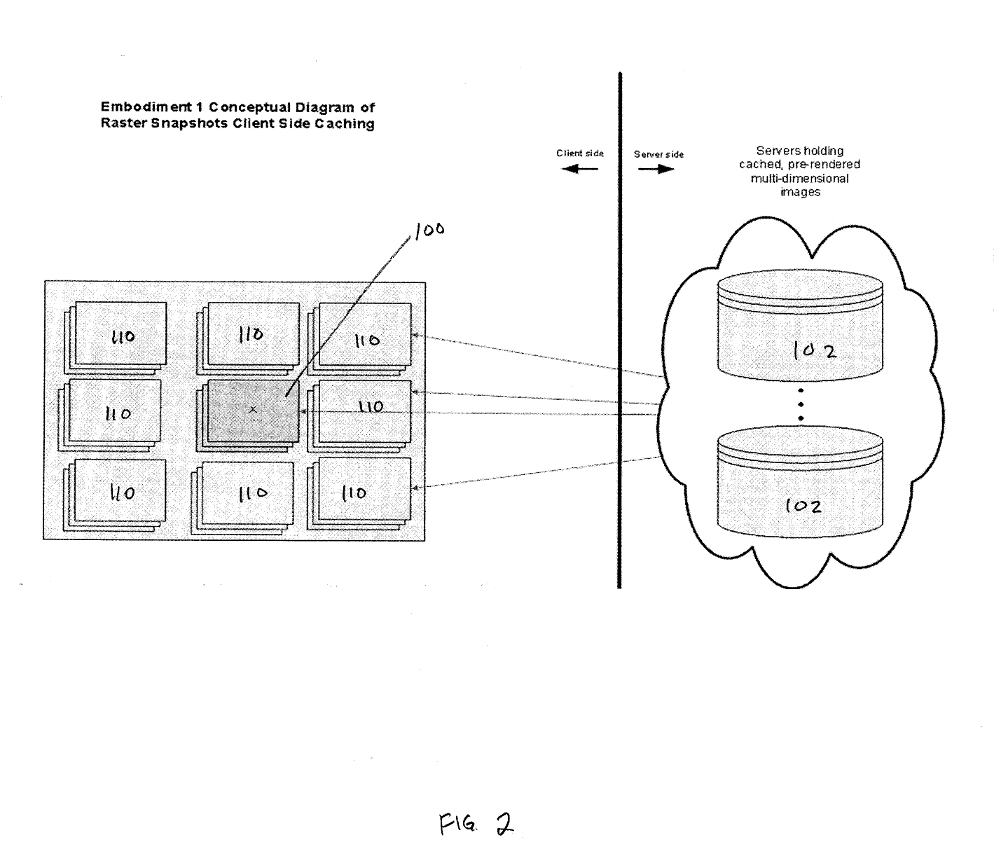

FIG. 2 shows a conceptual diagram of a first embodiment of the invention. In this embodiment, rasterized images are obtained from one or more databases 102, located on a server. Databases 102 contain pre-rendered, multi-dimensional images representing any type of data. The user is viewing, on the client side, image 105 in a browser window. The client side application utilizes an asynchronous streaming cache mechanism, such as AJAX (Asynchronous Java and XML), to continue to cache neighboring or adjacent rasterized images 110, while the user is viewing image 105. The caching enables a more fluid and faster application response by downloading the neighboring views 110, which are likely to be viewed by the user in the near future.

Each neighboring area 110 represents a unique slice of the rendered data. For example, the client application may display rasterized image 105 which has a specific set of viewing parameters such as location, tilt, data settings, etc. Adjacent rasterized images 110 may actually be multiple renderings of the adjacent 3D space, viewed with modified parameters, for example, different elevations above the surface, different camera tilt values, etc.

One the server side, with respect to embodiment 1, multiple databases 102 and multiple servers could be used for load balancing or to provide different coverages or different combinations of coverages. For example, one server might have perspective rasterized images utilizing topographical data while another server may contain perspective rasterized images utilizing aerial data. The service could contain other types of spatial or temporal referenced data such as stock market information, etc. The distribution of data in multiple data bases 102 on multiple servers applies to all embodiments of the invention.

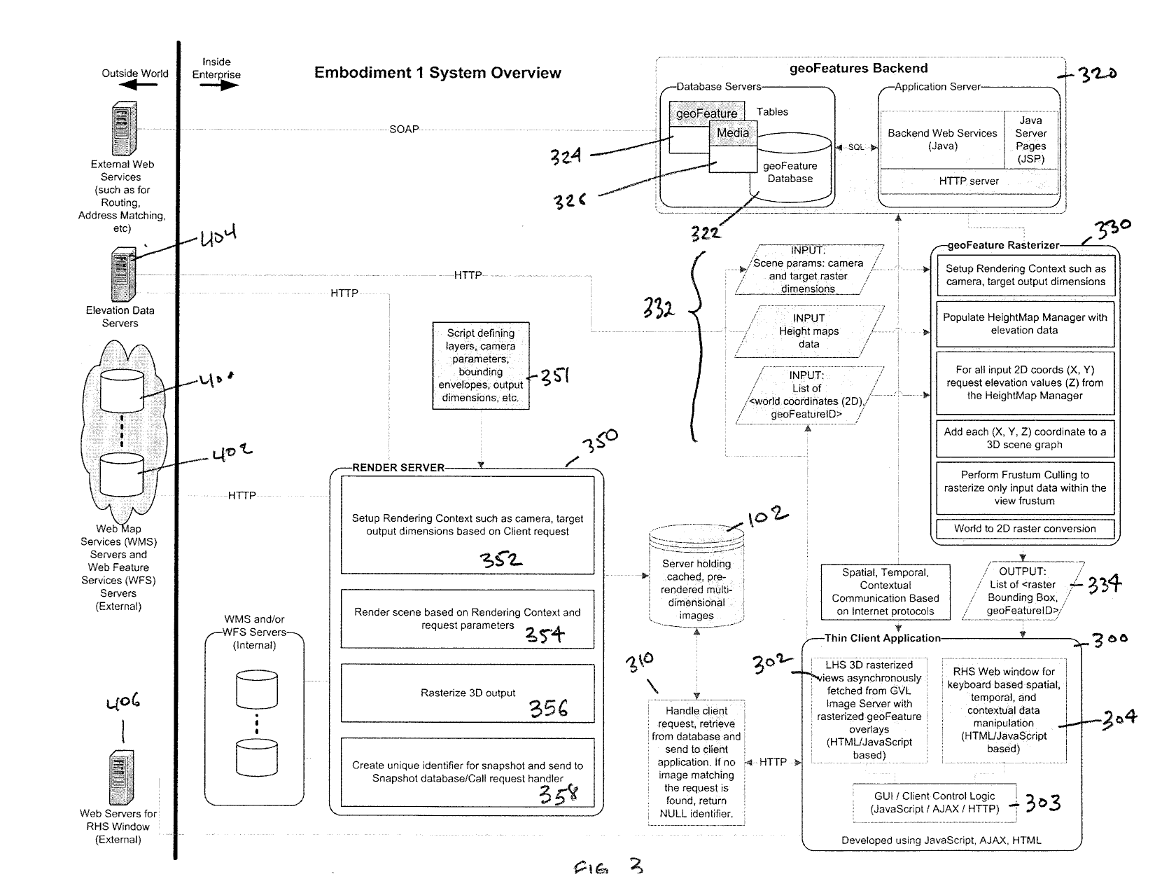

FIG. 3 shows the components and data flow of the first embodiment of the invention. On the client side the user access the application using a typical commercial off the shelf web browser 300, such as Internet Explorer by Microsoft.

Control logic 303 running within browser 300 coordinates the overall graphical user interface being displayed by browser 300 and the interaction between image display widget 302 and data widget 304. This component is preferably implemented in JavaScript/AJAX and HTTP. Control logic 303 may also be responsible for displaying navigation buttons to manipulate the view of the currently displayed image.

Data widget 304 is responsible for handling keyboard input and displaying spatial, temporal and conceptual data regarding the currently displayed image and any selected geoFeatures within the image.

Image display widget 302, is responsible for displaying rasterized images retrieved from server 310. When a user requests a specific image, the request consists of a location, camera settings, elevation, tilt, and any other parameters necessary to identify a specific image. The parameters are passed to image server 310, preferably via an HTTP request. Image server 310 checks to see if the requested image is cached in database 102, and, if so, serves the image to browser widget 302 for display. In this embodiment of the invention, if the requested image is not cached in database 102, the request fails and no image is displayed.

Image display widget 304 may also asynchronously request additional images that the user is likely to want to see, based on the current image being viewed. These images are shown in FIG. 2 as reference number 110. Images 110 can be requested asynchronously from server 310. Preferably, AJAX and HTML is used to load additional cached neighboring images from database 102.

Server 310 contains at least one database 102 containing pre-rendered multi-dimensional images representing perspective snapshots of the data set. Note that in this embodiment, the rasterized images are pre-loaded into database 102 and cannot be generated on the fly based upon a request from the user. Therefore, should user request an image not in the database, the server will be unable to comply with the user's request. There is no capability for image server 310 to render the rasterized image on the fly.

GeoFeatures may also be displayed layered over the rasterized images. GeoFeatures backend 320 is responsible for creating, storing and serving geoFeatures. GeoFeatures backend 320 includes database where geoFeatures are stored. Included is vector data 324 providing the location of the geoFeatures, as well as any ancillary data 326 associated with the geoFeatures, such as images, video, sound, behaviors, etc.

The geoFeatures are stored in the database 104 as vector data which is then projected into 2D space for client-side display on the rasterized perspective snapshots via the geoFeature rasterizer 307, utilizing input parameters 332. GeoFeature rasterizer 330 outputs, in box 334, the projection of the boundaries of the geoFeature on the 2D rasterized image. The boundaries may consist of a single point (may be multiple pixels), several points representing a segmented line, or several points representing the vertices of a polygon of any shape.

Browser 300 is aware of the boundaries of rendered geoFeatures, and will perform a task, such as displaying information in a window pane controlled by data widget 304 regarding the geoFeature, when the user selects a particular geoFeature by clicking with a mouse or by other means. The geoFeature database 322 may be searched for a particular set of geoFeatures to be rasterized and associated with the rasterized image through user search criteria entered into data widget 304. The client application makes requests to geoFeature backend 320 which then selects geoFeatures relevant to the user request to be rasterized and sent to the client application to be displayed client-side as an overlay on the rasterized perspective snapshot of the data being displayed.

Rasterized images are pre-loaded into database 102 via render server 350. Render server 350 takes input parameters 351 which may be, for example, location, camera settings, elevation, requested data layers, etc., and sets the rendering context in box 352. The parameters are used to render a rasterized perspective view of the scene's multi-dimensional data. The requested scene is rendered based on the rendering context in box 354. The 3D scene is then rasterized in to a 2D image in box 356, assigned a unique ID number and stored in database 102. for later recall.

In this embodiment of the invention, the viewing parameters, at least for GIS applications, such as camera orientation (heading, tilt, altitude) could be infinitely changeable in reality, but may be limited to a finite number of options for each parameter, such as limiting heading to N, NE, E, SE, S, SW, W, NW; tilt limited to 0, 30, 60, 90 degrees; elevation limited to 100 m, 250 m, 500 m, 750 m, 1000 m. This approach provides ample rasterized images to simulate the effect of seamless 3D navigation, but limits the size of the database containing the pre-cached images.

The imagery used to render the images is selected from various sources, such as internal or external Web Mapping Service (WMS) 400 or a Web Feature Service (WFS) 402 which provide such data. Elevation data may be provided by an external elevation data server 404. Data displayed by data widget 304 may also be obtained from an external sources, such as web server 406.

The second, and preferred, embodiment of the invention is similar to the first embodiment of the invention in that a purely thin client is utilized on the client side. The difference between the first and second embodiments is that the second embodiment allows on the fly data retrieval and rasterization of multi-dimensional scenes based upon request by the users in real time.

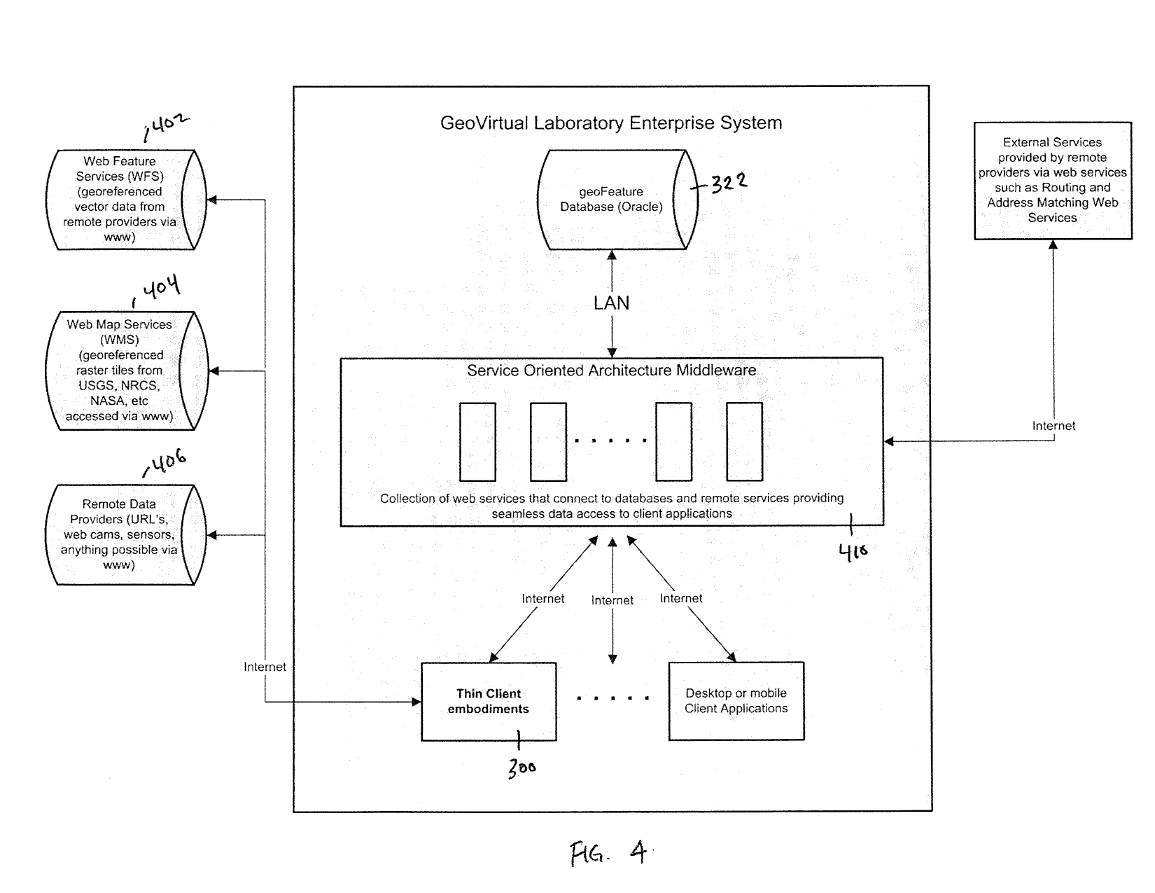

FIG. 4 shows the retrieval of various data from outside services utilized by the purely thin client embodiments, in the first embodiment the services are used to create a finite number of rasterized perspective snapshots and to pre-load the snapshot database 102. In the second embodiment the system is expanded to enable client-side driven request handling to collect the data needed to fulfill requests from users in real time and to perform dynamic server-side rendering and return rasterized perspective snapshots to the client application. Data may be drawn from various sources such as WFS servers 402 which may provide vector data from remote providers. WMS servers 404 may provide raster tiles from map services such as the U.S. Geological Services, NASA, etc. Various other types of data may be obtained from remote data providers 406 which may include data for example from web cams, external sensors or any other remote data source that may provide data of interest to the user. The user may specify which data sources are to be used to composite the rasterized image.

The service orientated architectural middleware 410 includes services that will take data drawn from the various sources, 402, 404 and 406 and rasterize it into images which are viewable on the thin client side via desk top or mobile client applications. The geoFeature database 104 feeds information regarding defined geoFeatures into the rendering engine 410 such that the geoFeatures are included in the rasterized images which are sent to the thin client 300.

The thin client embodiments are critical when mobile devices equipped with a standard web browser 300 capable of browsing and displaying simple images representing various renderings of the data of interest are used as the user interface to the system.

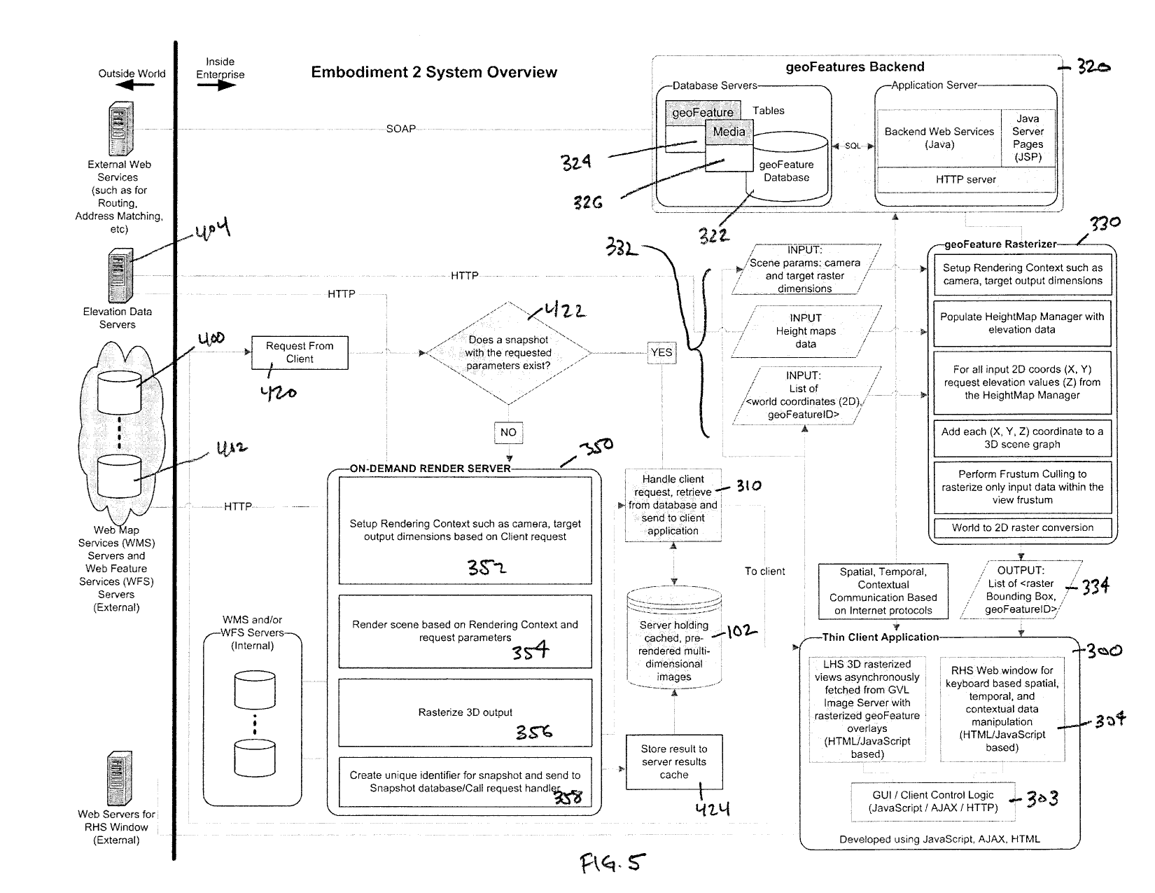

FIG. 5 shows a block diagram and data flow of the preferred embodiment of the invention. The embodiment is almost identical to the first embodiment shown in FIG. 3. However, this embodiments is capable of taking asynchronous requests from the thin client application 300 and fetching the data necessary to fulfill the request real time.

Requests from client 300 are received at box 420, and, in box 422, the server determines if a rasterized image with the requested parameters already exists in database 102. If so, the data is retrieved in box 310 from server database 102 and sent to client 300 for display as a rasterized image by image display widget 302.

If it is determined that the requested image is not in server database 102, the requested image must be rendered real time by on-demand render server 350, identical to render server 350 in FIG. 3. Depending upon the type of request, on-demand render server 350 may draw information from various web map services 400 and web feature services 402. In addition, data may be obtained from elevation data servers 404. Requests to the elevation data servers, web map services and web feature services are typically standard HTTP requests. This data is gathered and may be cached within render server 350 for later use.

Once render server 350 has produced a rasterized image and assigned an ID, it is stored in server database 102 by box 424. The request is then fulfilled by box 310.

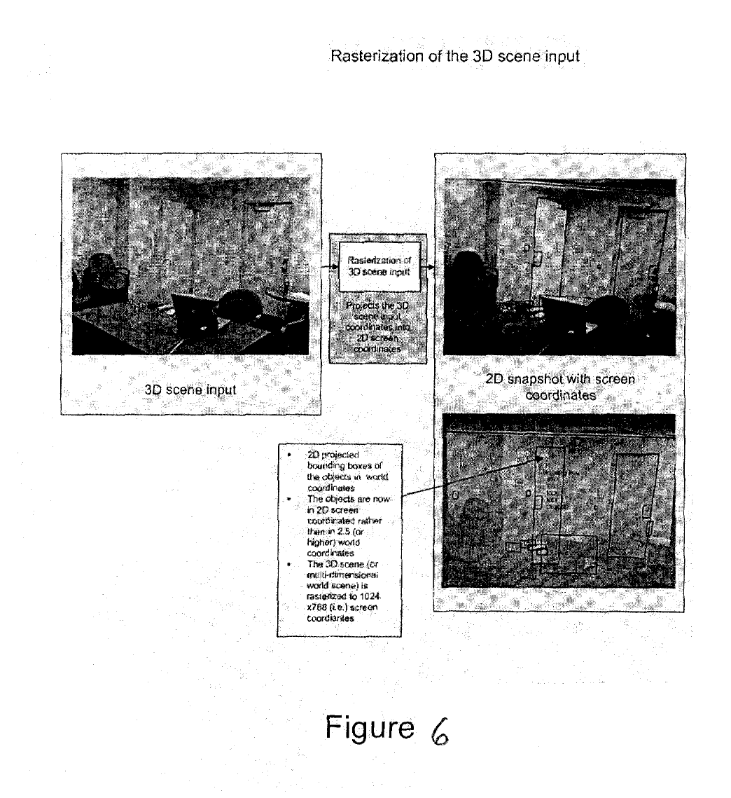

The rasterization of the multi-dimensional input scene encompasses the identification of each geoFeature in the scene. A bounding box is created around the geoFeature and an ID is assigned to each bounding box. This is shown in FIG. 6. The rasterization process is automatic, and it will also provide for decomposition of the larger bounding boxes that encompass bounding boxes for smaller objects inside. The bounding boxes will record the SW and NE corners coordinates as well as the bounding box ID. Once the scene is rasterized, the selection of geoFeatures as well as rasterized objects within the scene will be available through mouse clicking, and searches against the object within the rasterized scene could be performed by entering search criteria in the data widget 304 portion of the thin client application.

In the same token, the creation of geoFeatures is available through menu selection (point, line or polygon) and mouse clicking. The user can create a geoFeature by clicking on the 2D screen location of the desired object. The 2D screen coordinates are projected into multi-dimensional scene coordinates and stored in geoFeatures database 322 for future access.

The procedure to add geoFeatures already existing in the database is identical to the process for the first embodiment of the invention.

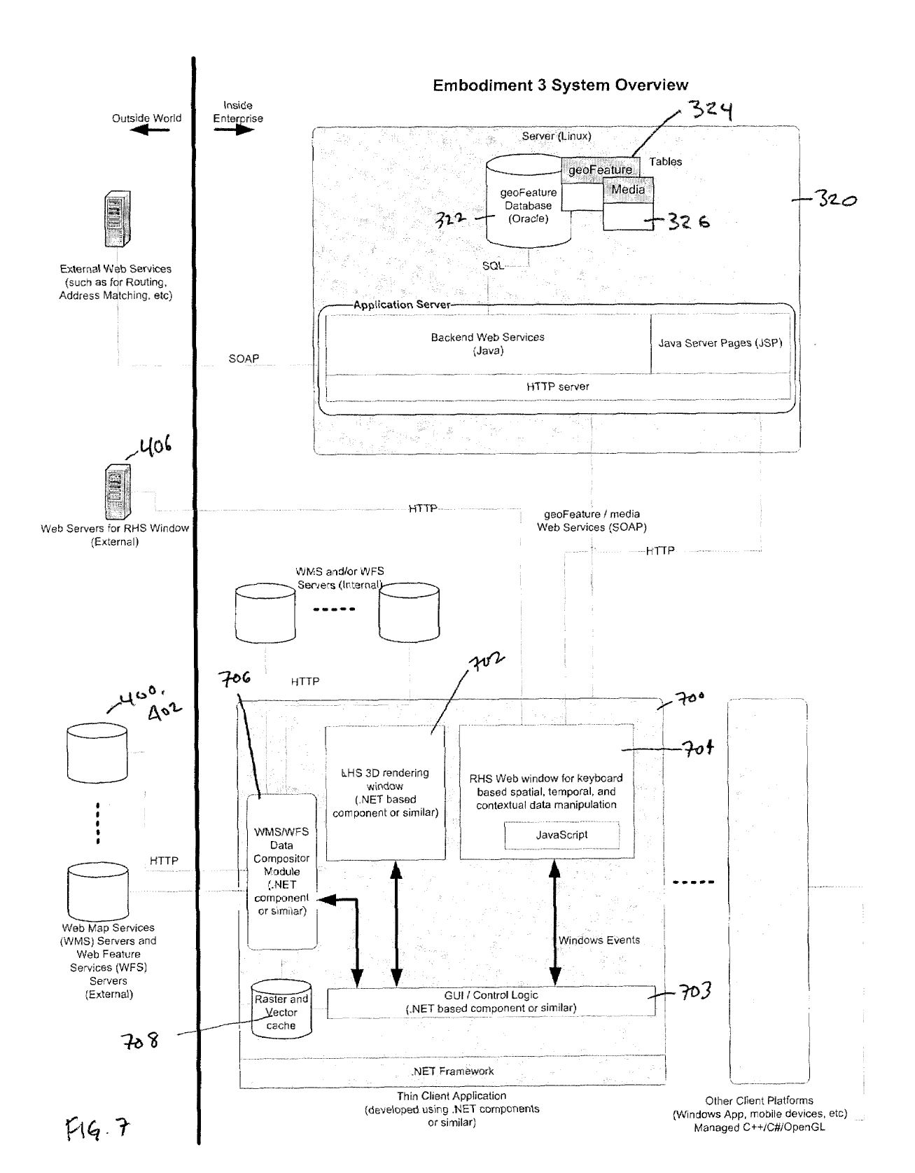

The third embodiment of the invention is shown in FIG. 7 and differs from the purely thin client version of the invention in that the rendering is done client side via a multi-dimensional dynamic render application which is embedded within the web browser. This could be implemented using a technology such as Shockwave, Java 3D, embedded .NET or any similar render language.

In this embodiment of the invention all functions performed by render server 350 in the first two embodiment so f the invention are now performed client side in the dynamic render application. The 3D rendering window 702, instead of being HTML or JavaScript based or similar is now preferably .NET based display module and a JavaScript/HTML data widget 704. The WMS/WFS compositor 706 performs the functions render server 350 in previous embodiments, of retrieving data from web map services 400 and web feature services 402 and compositing it into a rasterized image.

Packaged data retrieved from these sources can include, but is not limited to terrain data, draped imagery, vector data, 3D models, geoFeatures, volumetric data, etc. The client-side rendering requires that the client download all supporting data layers, such as height maps, composite the data (such as drapes) client-side, fetch and insert the relevant geoFeatures, etc. All this data is then processed and rendered by the client-side render engine.

Embedded application 700 also includes a cache 608 that caches raster and vector data collected from outside data sources. The data widget 704 may collect data independently from external web service 406 for display in the informational pane of the browser window.

In all embodiments of the invention, the geoFeatures are preferably stored as vector data within geoFeature database 104 preferably on a server external to the client. Note that the geoFeatures database 322, in all embodiments, includes information regarding the geoFeatures such as location, elevation, etc. (324) and, in addition, includes a separate table for related media regarding the particular geoFeature (326).

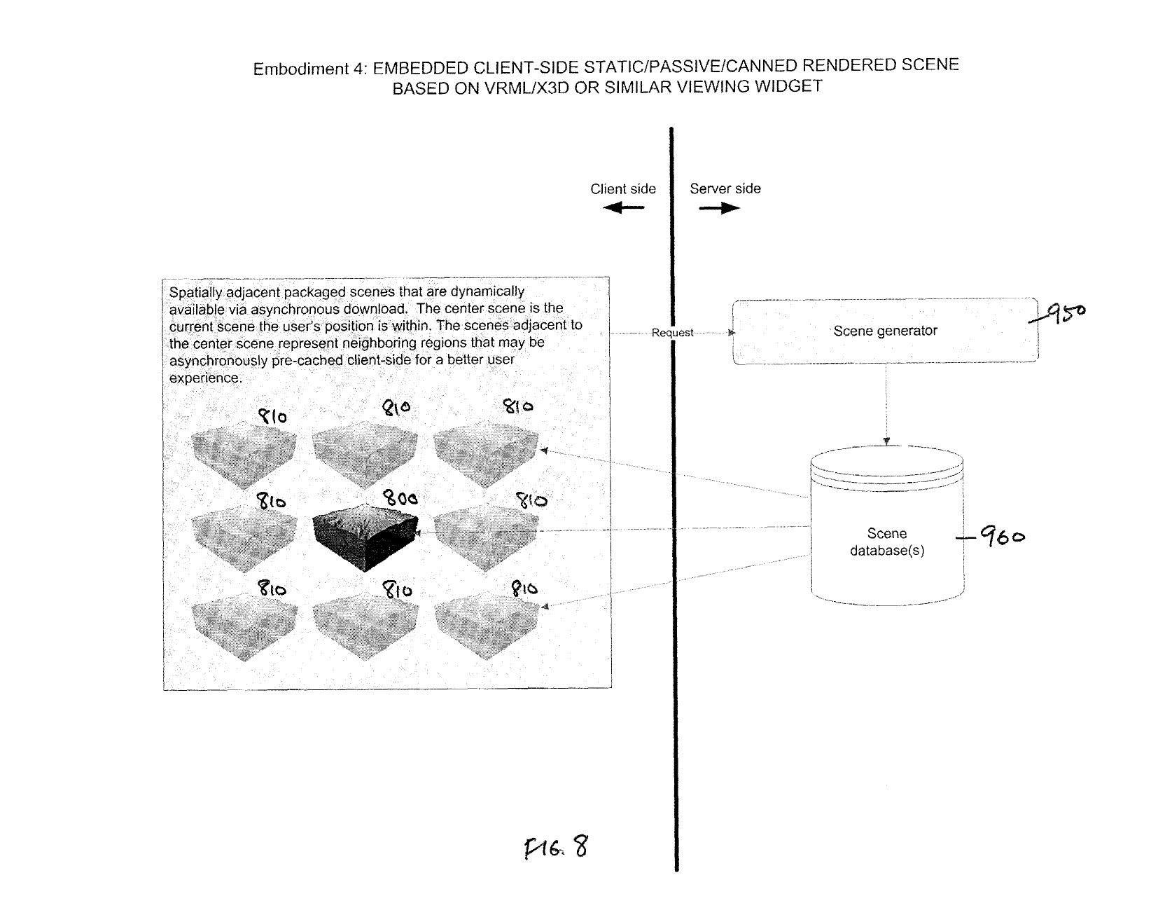

FIG. 8 shows an overview of the fourth and final embodiment of the invention. This embodiment requires the installation of a plug-in within the client side web browser that is able to interpret VRML, X3D or a similar or equivalent multi-dimensional scene description language. In this embodiment, requests from the client side are made to scene generator 950 on the server side. Scene generator 950 selects various scenes from the scene database 960 and sends them as multi-dimensional models expressed in a scene description language to the client side, where they are interpreted by the plug-in to the client side web browser. As with the first and second embodiments, as the user views a particular scene 800, adjacent scenes 810 are fetched asynchronously from the scene database such that the user transition from the scene being viewed 800 to an adjacent scent 810 appears seamless and happens in a timely manner.

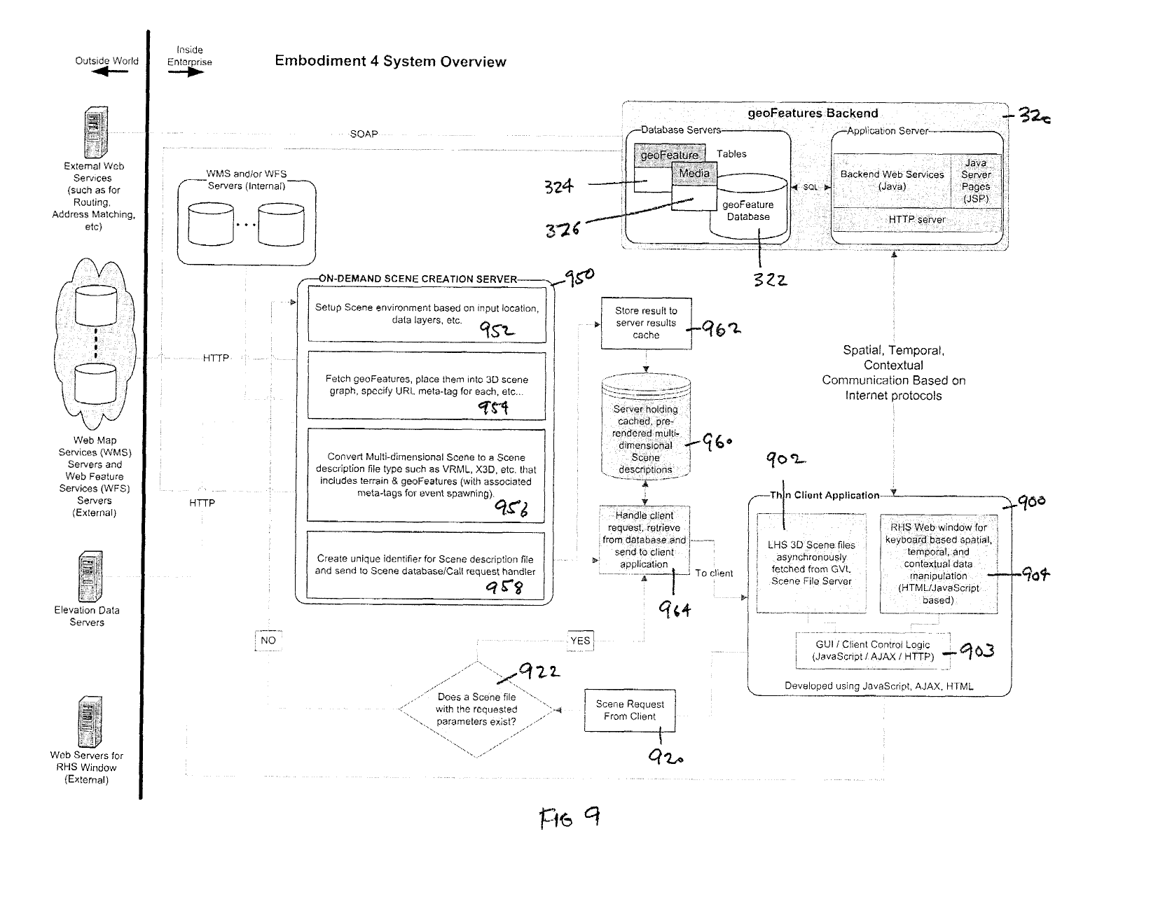

FIG. 9 shows the specific implementation of the fourth embodiment of the invention. The client application 900 includes scene file fetch and render widget 902, which requests and receives scene files from server 960, interprets the scene description language in the scene files and renders the images. Widget 902 also asynchronously requests adjacent scene files 810. Data widget 904 is very similar to data widget 304 in the first and second embodiments, and is still preferably HTML and JavaScript based.

In this embodiment, when request 920 is made from client for a scene, it is determined, in box 922, if the requested scene with the requested parameters exists in server database 960. If the requested scene is in server database 960, it is sent to the client in box 964 as a scene descriptor in the scene descriptor language. If the scene does not exist in the server database 960, the scene is created dynamically in the on-demand scene creation server 950.

In box 952, the scene environment is set up based on the input parameters, such as location, camera settings, elevation, requested data layers, etc. In box 954 the geoFeatures are fetched from geoFeature backend 320 and placed into the 3D scene. In box 956, the multi-dimensional scene is converted to a scene descriptor language, such as VRML or X3D. GeoFeatures are supplied with associated meta-tags for event spawning when they are selected by the user in the display window. In box 968, an ID is assigned to the scene description, and the scene description and ID are sent to box 962 for storage in server database 960. The user request is also fulfilled at this point by sending the scene description language to client 900.

Data widget 904 in Client 900 collects ancillary data regarding the geoFeatures from geoFeature backend 320 independently of scene creation server 950, when a particular geoFeature is selected by the user.

Several embodiments of the invention have been disclosed and various implementation details have been discussed with respect to each embodiment. It should be understood by those of skill in the art that many implementations, utilizing various languages, communications protocols, etc. are possible. These variations are contemplated to be within the scope of the invention, which is described by the following claims.

We claim:

1. A method of displaying multi-dimensional data comprising the steps of:
a. receiving requests from a client, said request including one or more parameters;
b. sending rasterized images to said client in response to said requests; and
c. sending raster coordinates of vector objects overlaying said rasterized images.

2. The method of claim 1 wherein said rasterized images are retrieved from a database and sent to said client.

3. The method of claim 2 wherein said rasterized images are indexed in said database with a unique identifier which is dependent upon said parameters.

4. The method of claim 1 further comprising the steps of:
a. collecting data from various servers;
b. compositing said data into a multi-dimensional model; and
c. rasterizing said scene into a two dimensional image.

5. The method of claim 3 further comprising the steps of:
a. assigning a unique identifier to said rasterized image, said unique identifier being based on said parameters; and
b. storing said rasterized image in a database indexed by said unique identifier.

6. The method of claim 1 further comprising the steps of:
a. retrieving additional information regarding said objects overlaying said rasterized images; and
b. sending said additional information to said client.

7. The method of claim 1 wherein said objects overlaying said rasterized images may be points, segmented lines or polygons.

8. The method of claim 1 wherein said parameters include camera settings, elevations, and requests for various data layers to be included in said rasterized image.

9. The method of claim 8 wherein said data layers are retrieved from servers accessible over the internet.

10. The method of claim 1 further comprising the step of sending a script to said client, said script containing instructions for the display of said rasterized image and instructions for the rendering of navigational buttons to change.

11. The method of claim 10 wherein said script also contains instruction for the display of a window containing said additional information regarding said objects overlaying said rasterized image.

12. The method of claim 10 further comprising receiving asynchronous requests for additional rasterized images related to said original rasterized image.

13. The method of claim 10 wherein said images are related based on location.

14. A system for serving rasterized images of multi-dimensional layered data comprising:
a. a render server module, said render server module performing the functions of collecting data layers based on a request received from a client, rendering a scene based on said collected data layers and additional parameters in said request, rasterizing said rendered scene into a two dimensional image and assigning a unique identifier to said rasterized image;
b. a cache, for the storage of said rasterized images; and
c. a server, for fulfilling said request received from said client either by retrieving the requested rasterized image from said cache or by requesting said render server module to create said rasterized image and sending said created rasterized image to said client and to said cache.

15. The system of claim 14 wherein said render server module collects said data layers from one or more servers accessible over the internet.

16. The system of claim 15 wherein said servers include WMS and WFS servers.

17. The system of claim 14 further comprising:
a. an object database for the storage of objects overlaying said rasterized images created by said render server module; and
b. a rasterizer module, for creating a bounding box in raster coordinates related to said rasterized image of one or more of said objects; and
c. an object server, for receiving requests for said objects from a client and for sending the coordinates of said bounding boxes to said requesting client for display overlaying said rasterized images.

18. The system of claim 17 wherein said bounding boxes can be points, segmented lines or polygons.

19. The system of claim 18 wherein said object database also includes ancillary information regarding said objects and further wherein said ancillary information is sent to said requesting client with intrinsic instructions for displaying said information.

20. The system of claim 19 wherein said ancillary information includes images, video, and text information.

21. The system of claim 20 wherein said client can provide information regarding new objects to be stored in said object database.

22. The system of claim 21 wherein said information regarding new objects includes location information and ancillary information.

23. The system of claim 19 further comprising one or more programs, scripts or descriptors, downloaded to said client, containing instructions for the displaying of said rasterized images, the displaying of said bounding boxes for said overlaid objects, and the displaying of said ancillary information.

24. The system of claim 19 wherein said programs, scripts or descriptors further include instructions for the display of widgets for collecting requests from a user for a new rasterized image, said widgets including navigational buttons and text boxes for the entry of search criteria.

25. The system of claim 17 wherein said request for a rasterized image is dependent upon the results of a search of said database of objects.

26. The system of claim 25 wherein said client is a mobile platform.

27. The system of claim 14 wherein the functions of said render server module are handled by an application embedded in a standard web browser on said client.

28. A system for serving multi-dimensional layered data comprising:
a. a scene creation server module, said scene creation server module performing the functions of collecting one or more data layers based on a request received from a client, compositing said one or more data layers into a multi-dimensional scene based on additional parameters included in said request, converting said multi-dimensional scene into a scene descriptor language and assigning a unique identifier to said scene descriptor;
b. a cache, for the storage of said scene descriptors; and
c. a server, for fulfilling said request received from said client either by retrieving the requested scene descriptor from said cache or requesting said scene creation server module to create said scene descriptor and sending said created scene descriptor to said client and to said server cache.

29. The system of claim 28 wherein said scene creation server module collects said data layers from servers accessible over the internet.

30. The system of claim 29 wherein said servers include WMS and WFS servers.

31. The system of claim 28 further comprising:
a. an object database for the storage of objects, said database including location information and ancillary information regarding said objects;
b. wherein said scene creation server module incorporates one or more of said objects into said scene descriptor as an additional data layer; and
c. an object server, for receiving requests for said objects from a client and for sending said ancillary data regarding one or more of said objects to said requesting client for display.

32. The system of claim 31 wherein said one or more objects can be represented in said scene descriptor as points, segmented lines or polygons.

33. The system of claim 31 wherein said ancillary information includes images, video, and text information.

34. The system of claim 33 wherein said client can provide information regarding new objects to be stored in said object database.

35. The system of claim 34 wherein said information regarding new objects includes location information and ancillary information.

36. The system of claim 31 further comprising one or more programs, scripts or descriptors, downloaded to said client, containing instructions for the displaying of said scene descriptors after interpretation by said client and the displaying of said ancillary information.

37. The system of claim 36 wherein said programs, scripts or descriptors further include instructions for the display of widgets for collecting requests from a user for a new scene descriptor, said widgets including navigational buttons and text boxes for the entry of search criteria.

38. The system of claim 31 wherein said request for a scene descriptor is dependent upon the results of a search of said database of objects.

39. The system of claim 38 wherein said client is a mobile platform.

40. The system of claim 28 wherein said scene descriptor language is VRML or X3D, or comparable scene description format.
